(19) United States
(12) Patent Application Publication
(10) Pub. No.: US 2026/0222200 A1
(43) Pub. Date: Jul. 30, 2026

(54) METHOD AND SYSTEM FOR HYBRID KEY SHARING AND SIGNING BASED ON PUBLIC-KEY CRYPTOGRAPHY AND POST-QUANTUM CRYPTOGRAPHY FOR ESIM

(71) Applicant: Electronics and Telecommunications Research Institute, Daejeon (KR)

(72) Inventors: Tae Sung KIM, Daejeon (KR); You Sung Kang, Daejeon (KR); Keon Woo Kim, Daejeon (KR); Sung Jin Yu, Daejeon (KR); Joon Young Lee, Daejeon (KR); Bo Heung Chung, Daejeon (KR)

(73) Assignee: Electronics and Telecommunications Research Institute, Daejeon (KR)

(21) Appl. No.: 19/083,815

(22) Filed: Mar. 19, 2025

(30) Foreign Application Priority Data
Jan. 24, 2025 (KR) 10-2025-0011040

(51) Int. Cl. H04L 9/30

(52) U.S. Cl. CPC H04L 9/30

(57) ABSTRACT

The present invention relates to a method and system for hybrid key sharing and signing based on public-key cryptography and post-quantum cryptography for eSIM. A method according to an aspect of the present disclosure may comprise: receiving a specific command indicating derivation of a shared secret according to a hybrid cryptography; transmitting information for a public key of a first cryptography and information for a public key of a second cryptography of eSIM; receiving information for a public key of the first cryptography and encapsulated key material related to the second cryptography of a server; and deriving the shared secret according to the hybrid cryptography by deriving a first shared secret for the first cryptography and a second shared secret for the second cryptography.

### CROSS-REFERENCE TO RELATED APPLICATIONS

This application claims the benefit of earlier filing date and right of priority to Korean Application No. 10-2025-0011040, filed on Jan. 24, 2025, the contents of which are all hereby incorporated by reference herein in their entirety.

### TECHNICAL FIELD

The present disclosure belongs to the field of secure communication technology, and more particularly, relates to a method and system for hybrid key sharing and signing based on public-key cryptography and post-quantum cryptography (PQC) for an embedded Subscriber Identity Module (eSIM).

### BACKGROUND

Security is becoming an increasingly important issue in modern communication systems, and secure authentication and data protection are essential, especially as small devices such as Internet of Things (IoT) devices are connected to networks.

In this environment, embedded Subscriber Identity Module (eSIM) is built into the device, unlike the conventional physical SIM card, and provides the ability to download and manage profiles remotely. eSIM is highly flexible as it is easy to switch between mobile service providers and can connect to various communication networks without replacing the physical chip.

However, due to the nature of eSIM, secure communication with the network is very important, and for this, strong encryption technology is required.

### SUMMARY

The technical object of the present disclosure is to provide a hybrid key sharing and signing system that combines conventional public key cryptography (Asymmetric Cryptography) and post-quantum cryptography (PQC) in a communication environment using eSIM.

The technical objects to be achieved by the present disclosure are not limited to the above-described technical objects, and other technical objects which are not described herein will be clearly understood by those skilled in the pertinent art from the following description.

A method for securely key sharing in a hybrid cryptography according to an aspect of the present disclosure may comprise: receiving a specific command indicating derivation of a shared secret according to the hybrid cryptography; transmitting information for a public key of a first cryptography and information for a public key of a second cryptography of an embedded Subscriber Identity Module (eSIM), to a server, based on the specific command; receiving information for a public key of the first cryptography and encapsulated key material related to the second cryptography of the server, from the server; and deriving the shared secret according to the hybrid cryptography by deriving a first shared secret for the first cryptography and a second shared secret for the second cryptography.

An apparatus of securely key sharing in a hybrid cryptography according to an additional aspect of the present disclosure may comprise at least one processor and at least one memory, and the processor may be configured to: receive a specific command indicating derivation of a shared secret according to the hybrid cryptography; transmit information for a public key of a first cryptography and information for a public key of a second cryptography of an embedded Subscriber Identity Module (eSIM), to a server, based on the specific command; receive information for a public key of the first cryptography and encapsulated key material related to the second cryptography of the server, from the server; and derivate the shared secret according to the hybrid cryptography by deriving a first shared secret for the first cryptography and a second shared secret for the second cryptography.

A method for securely key sharing in a hybrid cryptography according to an additional aspect of the present disclosure may comprise: receiving a specific command indicating derivation of a shared secret according to the hybrid cryptography; transmitting information for a public key of a first cryptography and information for a public key of a second cryptography of a server, to an embedded Subscriber Identity Module (eSIM), based on the specific command; receiving information for a public key of the first cryptography and encapsulated key material related to the second cryptography of the eSIM, from the eSIM; and deriving the shared secret according to the hybrid cryptography by deriving a first shared secret for the first cryptography and a second shared secret for the second cryptography.

In various aspects of the present disclosure, the specific command may include at least one of information for a public key of the first cryptography, information for a private key of the first cryptography, information for a public key of the second cryptography, or information for a private key of the second cryptography.

Additionally, in various aspects of the present disclosure, information for the public key of the first cryptography, information for the private key of the first cryptography, information for the public key of the second cryptography, and information for the private key of the second cryptography may be configured based on either an identifier or a label.

Additionally, in various aspects of the present disclosure, the specific command may further include information encapsulating a shared secret for the second cryptography.

Additionally, in various aspects of the present disclosure, the shared secret according to the hybrid cryptography may be derived by combining the second shared secret to the first shared secret, for example, by concatenation.

Additionally, in various aspects of the present disclosure, the first cryptography may correspond to a public key cryptography, and the second cryptography may correspond to a post-quantum cryptography.

Additionally, in various aspects of the present disclosure, the above method/apparatus may further include a step/operation of receiving a command for initializing a signature generation procedure according to the hybrid cryptography; and a step/operation of performing a signature exchange procedure with the server in response to the command.

Additionally, in various aspects of the present disclosure, the command may include information for a private key of the first cryptography and information for a private key of the second cryptography.

Additionally, in various aspects of the present disclosure, the information for the private key of the first cryptography and the information for the private key of the second cryptography may be configured based on either an identifier or a label.

According to an embodiment of the present invention, the present invention has a technical effect of solving the security problem of existing public key cryptography due to the development of quantum computers, while maintaining compatibility with conventional network and server infrastructure, thereby enabling safe and efficient communication between Internet of Things (IoT) devices and various digital devices.

Effects achievable by the present disclosure are not limited to the above-described effects, and other effects which are not described herein may be clearly understood by those skilled in the pertinent art from the following description.

### BRIEF DESCRIPTION OF THE DRAWINGS

The accompanying drawings, which are incorporated in and are incorporated in and are intended to aid in the understanding of the present disclosure, provide embodiments of the present disclosure and, together with the detailed description, serve to explain the technical features of the present disclosure.

FIG. 1 illustrates a key sharing procedure between an eSIM and a server in a hybrid cryptography for an eSIM according to an embodiment of the present disclosure.

FIG. 2 illustrates a signature-related procedure between an eSIM and a server in a hybrid cryptographic (P for an eSIM according to an embodiment of the present disclosure.

FIG. 3 illustrates an operational flowchart of method for applying a hybrid cryptographic scheme for an eSIM according to an embodiment of the present disclosure.

FIG. 4 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Conventional public key cryptography (Asymmetric Cryptography) is very useful for ensuring confidentiality, integrity, and authentication of data. Representative algorithms for public key cryptography include Rivest Shamir Adleman (RSA) and Elliptic Curve Cryptography (ECC), which operate by encrypting data and verifying signatures using two keys (e.g., a public key and a private key).

Public key cryptography is used as a reliable secure communication method worldwide, but with the development of quantum computing, there is a possibility that conventional public key cryptography may become vulnerable. In other words, quantum computers may perform complex mathematical operations very quickly, so conventional public key cryptography algorithms may no longer be secure.

Considering these points, Post-Quantum Cryptography (PQC) technology may be applied. PQC refers to a cryptographic algorithm that can resist attacks from quantum computers, and is expected to play an important role in the future security environment. PQC consists of various algorithm families (e.g., lattice-based cryptography, polynomial-based cryptography, hash-based signature, etc.) and has the characteristic of being safe even against the computational power of quantum computers.

However, using conventional public key cryptography and PQC cryptography separately increases system complexity and makes it difficult to apply to existing IoT devices and server environments.

Considering these points, a hybrid cryptosystem combining conventional public key cryptography and POC cryptography may be efficient and stable. Such a hybrid method may combine two cryptosystems to take advantage of both the efficiency of conventional cryptography and the quantum resistance of PQC, thereby providing an efficient security solution for the quantum computer era.

In the present disclosure, a method and system for hybrid key sharing and signature generation combining public-key cryptography and POC in an embedded Subscriber Identity Module (eSIM) environment are proposed.

The proposed method and system of the present disclosure relates to an extension of cryptographic technology that applies conventional public key cryptography and quantum-resistant cryptography (PQC) to ensure secure communication between Internet of Things (IoT) devices and servers.

Specifically, the proposed method and system of the present disclosure may have the following purposes.
Enhanced security: By merging conventional cryptographys (e.g. public key cryptography) with PQC in eSIM, it provides a key sharing and signing system that is secure even against attacks by quantum computers.
Flexible cryptography system: A hybrid method that combines the features of conventional cryptographys (e.g., public key cryptography) and PQC, allowing the eSIM to maximize the advantages of each cryptography when communicating with the server.
Low cost and high efficiency: Adding PQC to conventional cryptographys (e.g., public key cryptography) minimizes communication costs and computational complexity, and extends conventional standards (e.g., IoTSAFE standard) to reduce the cost of implementing new systems.
Secure signature and key updating: Supports continuous and secure signature and key updating procedures in eSIM environments through a hybrid key sharing and signature system.
Compatibility with conventional infrastructure: Compatible with conventional server and network infrastructure, and may significantly enhance security levels without additional major modifications.

In this regard, the global system for mobile communications association (GSMA), a mobile standards organization, has established and manages the IoT SIM Applet for Secure End-2-End Communication (IoTSAFE) standard, which utilizes SIM as a hardware security device or root of trust to complete end-to-end security in Internet of Things (IoT) devices. Currently, the IoTSAFE standard ensures secure communication between IoT devices and servers by utilizing existing public key cryptography.

However, as mentioned above, with the development of quantum computers, concerns about the security of conventional public key cryptography are growing.

Therefore, in the present disclosure, a method and system for key sharing and generation/verification of signatures based on a hybrid approach that combines conventional public key cryptography and post-quantum cryptography (PQC) by extending the aforementioned IoTSAFE standard is proposed.

In the following disclosure, a specific method is proposed to replace the ‘ComputeDH’ command in the conventional IoTSAFE standard with the ‘ComputeSS’ command and to modify and add parameters for the ‘Compute Signature-Init’ command and the ‘Verify Signature-Init’ command so that key sharing and signature of the hybrid cryptography may be supported in an eSIM environment.

### Embodiment 1

This embodiment defines a command (e.g., the ‘ComputeSS’ command described above) for combining the key sharing process of the conventional public key cryptography and the PQC scheme, and describes a method for performing a procedure based on the command.

The ‘ComputeSS’ command proposed in the present disclosure may be a command that derivates a hybrid shared secret by combining the key sharing process of the conventional public key cryptography and the PQC cryptography.

The ‘ComputeSS’ command may be used in a key exchange process for stable communication between an eSIM (e.g., an eSIM card/device) and an external server. For example, a ‘ComputeSS’ command may be generated by a terminal equipped with an eSIM card/device, and the terminal transmits the ‘ComputeSS’ command to the eSIM card/device, and based on this, a key exchange process between the eSIM card/device and an external server may be performed/triggered.

Based on the ‘ComputeSS’ command, a secure shared key (e.g., a pre-master key) may be derivated by combining the shared secret of a conventional public key cryptography and the secret encapsulation of the PQC scheme.

The ‘ComputeSS’ command proposed in the present disclosure may include a command header defined as in Table 1 and a data field defined as in Table 2.

TABLE 1

| | | | Possible |
|---|---|---|---|
| Code | Length | Description | values |
| CLA | 1 | Class | |
| INS | 1 | ComputeSS command | 47h |
| P1 | 1 | P1 | |
| P2 | 1 | P2 | |
| Lc | 1 | Length of a Data field | |
| Le | 1 | Length of a response | 00h |
| | | message | |

TABLE 2

| Tag | Length | Value | Presence |
|---|---|---|---|
| 84h | 01h-14h | Conventional | Optional |
| | | cryptography Private key | |
| | | ID | |
| 85h | 01h-14h | Conventional | Optional |
| | | cryptography Public key | |
| | | ID | |
| 74h | 01h-3Ch | Conventional | Optional |
| | | cryptography Private key | |
| | | label | |
| 75h | 01h-3Ch | Conventional | Optional |
| | | cryptography Public key | |
| | | label | |
| 86h | 01h-14h | PQC cryptography Private | Optional |
| | | key ID | |
| 87h | 01h-14h | PQC cryptography Public | Optional |
| | | key ID | |
| 76h | 01h-3Ch | PQC cryptography Private | Optional |
| | | key label | |
| 77h | 01h-3Ch | PQC cryptography Public | Optional |
| | | key label | |
| 88h | variable | Encapsulated | Optional |
| | | cryptographytext with | |
| | | shared secret | |

Referring to Table 2, compared to the conventional ‘ComputeDH’ command, the data field of the ‘ComputeSS’ command proposed in the present disclosure may further include information related to the PQC method.

For example, as shown in Table 2, the data field of the ‘ComputeSS’ command may include, in addition to the information about the conventional cryptography, at least one of a private key ID for the PQC, a public key ID for the PQC, a private key label for the PQC, a public key label for the PQC, and a ciphertext/capsule encapsulating a shared secret. In this regard, for the private key/public key for the PQC, only one of the information for the ID and the information for the label may be included.

In addition, in a procedure based on the aforementioned ‘ComputeSS’ command, the data fields of the return message may be defined as in Table 3.

TABLE 3

| Name | Length | Value | Presence |
|---|---|---|---|
| Hybrid | variable | A hybrid combination of | Mandatory |
| Shared | | shared secret of | |
| Secret | | conventional | |
| | | cryptography and shared | |
| | | secret of PQC | |
| | | cryptography | |

The hybrid method of combining the results of the conventional cryptography (e.g., public key cryptography) scheme and the PQC scheme described above in the present disclosure may be configured by using the secret sharing and secret encapsulation, which are the results of two cryptographys, based on the standard and server cryptography processing methods.

For example, the result value may be obtained by simply concatenating secret sharing and secret encapsulation. This is an example, and a key sharing value for a hybrid method may be derivated through various methods.

With respect to Tables 1 to 3, the conventional cryptography may refer to the private key in the eSIM and the public key of the external server. In addition, the PQC cryptography may be configured with a data field by distinguishing between the case where key encapsulation is performed by the eSIM card/device and the case where key encapsulation is performed by the external server. For example, when the external server performs key encapsulation, the data field must refer to a ciphertext and a POC private key, and the ciphertext may be omitted in the return message.

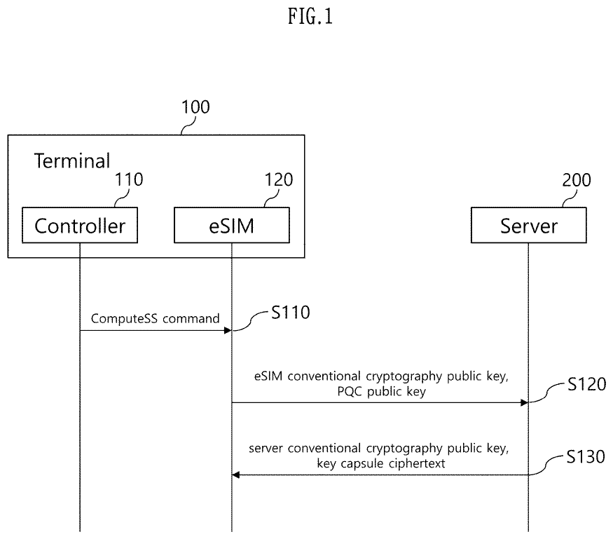

FIG. 1 illustrates a key sharing procedure between an eSIM and a server in a hybrid cryptography for an eSIM according to an embodiment of the present disclosure.

Referring to FIG. 1, a key sharing procedure between an eSIM and a server may be performed/triggered based on the ‘ComputeSS’ command proposed in the present disclosure.

Although FIG. 1 illustrates a key sharing procedure for a case where an eSIM receives a ‘ComputeSS’ command, a key sharing procedure for a case where a server receives a ‘ComputeSS’ command may also be considered, and this may be performed similarly to the procedure illustrated in FIG. 1.

For example, the terminal (100) may transmit a ‘ComputeSS’ command to the eSIM (120) through the control unit (110) (S110).

Based on the ‘ComputeSS’ command, the eSIM (120) can derivate a key pair for the conventional cryptography as well as a key pair for the PQC scheme. In addition, the server (200) may derivate a key pair for the conventional cryptography.

The eSIM (120) may transmit information for its (i.e., eSIM's) conventional cryptography public key and information for the PQC scheme public key to the server (200) (S120). Thereafter, the server (200) may transmit information for its (i.e., server's) conventional cryptography public key and key capsule ciphertext to the eSIM (120) (S130).

Based on the above-described procedures, the eSIM (120) may derivate a partial share of a conventional cryptography and a partial share from a decapsulation (e.g., a result derivated by decapsulating a keycapsule ciphertext received from a server). For example, the eSIM (120) may derivate a full key share by (simply) concatenating the two derivated partial shares. Here, the full key share may correspond to a secret share according to the hybrid scheme described above in the present disclosure.

In addition, based on the above-described procedures, the server (200) may derivate a partial share of a conventional cryptography and derivate the partial share with a key capsule (e.g., a secret key capsule derivated based on the PQC method). For example, the server (200) may derivate a full key share by (simply) concatenating the two derivated partial shares. Here, the full key share may correspond to a secret share according to the hybrid scheme described above in the present disclosure.

Based on this procedure, a secret/encrypted communication path between the eSIM (120) and the server (200) may be generated/configured.

Afterwards, an authentication procedure between the eSIM (120) and the server (200) may be performed. To this end, transmission/reception/exchange of a certificate may be performed between the eSIM (120) and the server (200), and a generation and verification procedure for a signature may be performed.

### Embodiment 2

This embodiment is about a method of defining a command (e.g., Compute Signature Init′ command) that starts/triggers a signature process in the hybrid method described above, and performing a procedure based on the command.

The ‘Compute Signature Init’ command may be a command that initializes a signature generation procedure in an eSIM. The ‘Compute Signature Init’ command may perform the role of selecting a conventional cryptography (e.g., public key encryption) and a POC cryptography, and starting the signing process by specifying a private key required for each method.

The command may be used as a first step in hybrid signature generation in an eSIM proposed in the present disclosure to prepare for signature generation.

The ‘Compute Signature Init’ command proposed in the present disclosure may include a command header defined as in Table 4 and a data field defined as in Table 5.

TABLE 4

| | | | Possible |
|---|---|---|---|
| Code | Length | Description | value |
| CLA | 1 | Class | |
| INS | 1 | Compute Signature-init | 2Ah |
| | | command | |
| P1 | 1 | P1 | Session |
| | | | request |
| P2 | 1 | P2 | Session |
| | | | number |
| Lc | 1 | Length of a data field | |
| Le | 1 | Length of a response | 00h |
| | | message | |

TABLE 5

| Tag | Length | Value | Presence |
|---|---|---|---|
| 84h | 01h-14h | Conventional cryptography | Optional |
| | | Private key ID | |
| 74h | 01h-3Ch | Conventional cryptography | Optional |
| | | Private key label | |
| 86h | 01h-14h | PQC cryptography Private | Optional |
| | | key ID | |
| 76h | 01h-3Ch | PQC cryptography Private | Optional |
| | | key label | |

Referring to Table 5, compared to the conventional ‘Compute Signature Init’ command, the data field of the ‘Compute Signature Init’ command proposed in the present disclosure may further include information related to the PQC scheme.

For example, as shown in Table 5, the data field of the Compute Signature Init command may include at least one of a private key ID for the PQC or a private key label for the PQC in addition to information for the conventional cryptography.

With respect to the hybrid method proposed in the present disclosure, the ‘Compute Signature Init’ command may command/designate to select a conventional cryptography (e.g., public key cryptography) and a POC cryptography used for signature. In the case of the ‘Compute Signature update’ command, changes may not be necessary even when considering the hybrid scheme.

In this regard, a hybrid signature combination scheme may be generated using two signatures (e.g., a public key cryptography-based signature and a POC-based signature) based on the standard and server's cryptographic processing methods.

For example, a signature in a hybrid scheme may be generated by simply connecting (e.g., concatenating) a public key cryptography-based signature and a POC-based signature. As an example, a signature in a hybrid scheme may be generated by various methods of combining the two signatures.

In addition, the ‘Verify Signature Init’ command may have a similar structure to the ‘Compute Signature Init’ command. Therefore, the ‘Verify Signature Init’ command for the hybrid method proposed in the present disclosure may be defined by replacing/changing the ID and label of the private key with the ID and label of the public key in the description related to the ‘Compute Signature Init’ command described above. In the case of the ‘Verify Signature update’ command, changes may not be necessary even when considering the hybrid scheme.

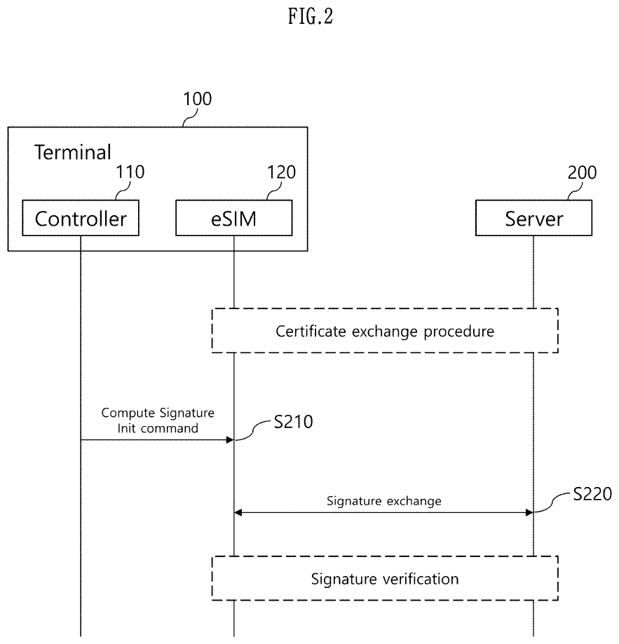

FIG. 2 illustrates a signature-related procedure between an eSIM and a server in a hybrid cryptographic scheme for an eSIM according to an embodiment of the present disclosure.

Referring to FIG. 2, a signature-related procedure between an eSIM and a server may be performed/triggered based on the ‘Compute Signature Init’ command proposed in the present disclosure.

Although FIG. 2 illustrates a key sharing procedure for a case where an eSIM receives a ‘Compute Signature Init’ command, a signature-related procedure for a case where a server receives a ‘Compute Signature Init’ command may also be considered, and this may be performed similarly to the procedure illustrated in FIG. 2.

For example, the terminal (100) may transmit a ‘Compute Signature Init’ command to the eSIM (120) through the control unit (110) (S210).

In response to the ‘Compute Signature Init’ command, the eSIM (120) may generate a hybrid signature according to the above-described method.

Afterwards, a signature exchange procedure between the eSIM (120) and the server may be performed (S220).

For example, the eSIM (120) may transmit the generated hybrid signature to the server (200) and request a signature from the server (200). Thereafter, the server (200) may generate its own hybrid signature based on the request and transmit the generated hybrid signature to the eSIM (120).

In addition, after the signature exchange procedure, a verification procedure for the hybrid signature may be performed between the eSIM (120) and the server (200). For example, the ‘Verify Signature Init’ command may be utilized in relation to the verification procedure. If the verification procedure for such a signature is completed, this may mean that the authentication procedure between the eSIM (120) and the server (200) is completed.

Additionally, prior to the procedure related to signing, a certificate exchange procedure may be performed between the eSIM (120) and the server (200).

For example, the eSIM (120) may generate a certificate including a conventional cryptography and a PQC cryptography. Specifically, the eSIM (120) may transmit a certificate including information for its (i.e., the eSIM's) conventional cryptography public key and information for a PQC scheme public key to the server (200). In addition, the server (200) may generate a certificate including a conventional cryptography and a PQC scheme cryptography. Specifically, the server (200) may transmit a certificate including information for its (i.e., the server's) conventional cryptography public key and information for a POC scheme public key to the eSIM (120).

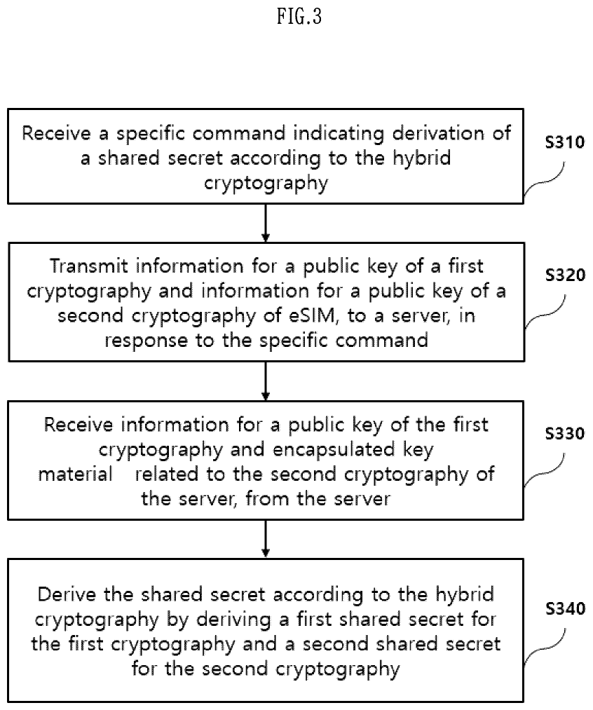

FIG. 3 illustrates an operational flowchart of a method for applying a hybrid cryptography for an eSIM according to an embodiment of the present disclosure.

Referring to FIG. 3, a representative example is described in which an eSIM receives a command proposed in the present disclosure (e.g., a command described in Embodiment 1 and Embodiment 2) and performs a procedure with a server. However, the scope of the present disclosure is not limited thereto, and a method in which a server receives a command proposed in the present disclosure and performs a procedure with an eSIM may also be considered.

In a method for securely key sharing in a hybrid cryptography of the present disclosure, an eSIM may receive a specific command (e.g., a ‘ComputeSS’ command) that indicates derivation of a shared secret according to the hybrid cryptography (S310).

For example, a specific command may include at least one of information for a public key of the first cryptography, information for a private key of the first cryptography, information for a public key of the second cryptography, or information for a private key of the second cryptography. In addition, the specific command may further include information in which a shared secret for the second cryptography is encapsulated.

In this regard, information for the public key of the first cryptography, information for the private key of the first cryptography, information for the public key of the second cryptography, and information for the private key of the second cryptography may be configured based on either an identifier or a label.

Afterwards, in response to the specific command, the eSIM may transmit/receive/exchange information to create a key share with the server.

Specifically, the eSIM may transmit information for its public key of its first cryptography and information for its public key of its second cryptography to the server (S320), and receive information for the public key of the server's first cryptography and encapsulated key material related to the second cryptography from the server (S330).

Based on this, the eSIM may derivate a first shared secret for the first cryptography and a second shared secret for the second cryptography, and may derivate a shared secret according to a hybrid cryptography using the two shared secrets (S340).

For example, a shared secret according to a hybrid cryptography may be derivated by concatenating the second shared secret to the first shared secret.

In relation to the above-described operations, the first cryptography may correspond to a public key cryptography, and the second cryptography may correspond to a post-quantum cryptography.

Additionally, the eSIM may receive a command (e.g., a ‘Compute Signature Init’ command) for initializing a signature generation procedure according to a hybrid cryptography, and perform a signature exchange procedure with a server in response to the command.

For example, the command may include information for a private key of the first cryptography and information for a private key of the second cryptography. At this time, the information for the private key of the first cryptography and the information for the private key of the second cryptography may be configured based on either an identifier or a label.

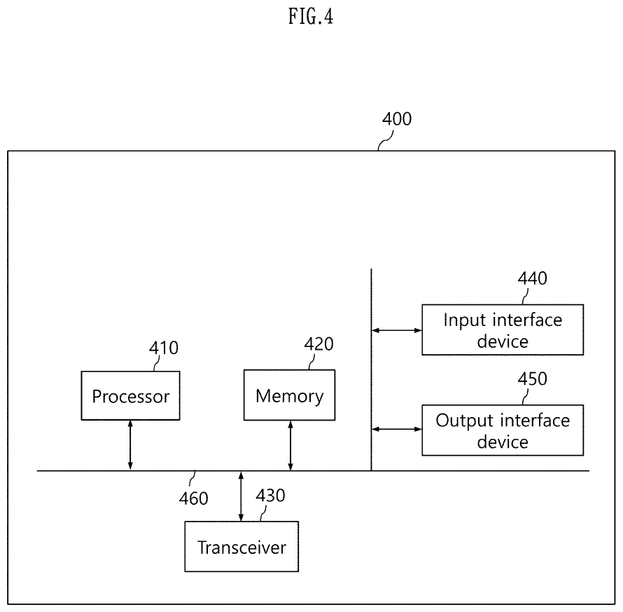

FIG. 4 is a block diagram illustrating an apparatus according to an embodiment of the present disclosure.

Referring to FIG. 4, a device (400) may represent a device implementing a method for hybrid key sharing and signature described in the present disclosure.

The device 400 may include at least one of a processor 410, a memory 420, a transceiver 430, an input interface device 440, and an output interface device 450. Each of the components may be connected by a common bus 460 to communicate with each other. In addition, each of the components may be connected through a separate interface or a separate bus centering on the processor 410 instead of the common bus 460.

The processor 410 may be implemented in various types such as an application processor (AP), a central processing unit (CPU), a graphic processing unit (GPU), etc., and may be any semiconductor device that executes a command stored in the memory 420. The processor 410 may execute a program command stored in the memory 420. The processor (410) may be configured to implement a hybrid method for key sharing and signature described based on FIGS. 1 to 3 described above.

And/or, the processor 410 may store a program command for implementing at least one function for the corresponding modules in the memory 420 and may control the operation described based on FIGS. 1 to 3 to be performed.

The memory 420 may include various types of volatile or non-volatile storage media. For example, the memory 420 may include read-only memory (ROM) and random access memory (RAM). In an embodiment of the present disclosure, the memory 420 may be located inside or outside the processor 410, and the memory 420 may be connected to the processor 410 through various known means.

The transceiver 430 may perform a function of transmitting and receiving data processed/to be processed by the processor 410 with an external device and/or an external system.

The input interface device 440 is configured to provide data to the processor 410.

The output interface device 450 is configured to output data from the processor 410.

In the eSIM-based communication environment proposed in the present disclosure, a hybrid key sharing and signature system combining conventional public key cryptography (Asymmetric Cryptography) and post-quantum cryptography (PQC) may have the following technical effects.

The proposed method/system of the present disclosure may have the effect of strengthening security against quantum computing attacks. Specifically, the hybrid scheme of the present disclosure combines the security of conventional public key cryptography and the quantum-resistant characteristics of POC cryptography, thereby enabling secure communication that may cope with the development of quantum computers. Although quantum computers have the potential to perform attacks on conventional public key cryptography systems very quickly, the hybrid scheme of the present disclosure provides protection against such attacks.

In addition, the proposed method/system of the present disclosure may have a technical effect of supplementing the stability of the PQC scheme. Specifically, the current PQC scheme is theoretically known to be safe from quantum computing attacks, but its stability is not completely guaranteed. The hybrid scheme of the present disclosure supplements the stability of the PQC scheme by using the conventional public key cryptography together with the PQC scheme instead of using only the PQC scheme, and even if a vulnerability is found in the PQC scheme, additional security may be provided through the existing public key cryptography. Through this, a stable security system that is equipped with both conventional technology and preparation for future quantum computing may be built.

In addition, the proposed method/system of the present disclosure may have a technical effect of providing a flexible security system suitable for an eSIM environment. The hybrid scheme of the present disclosure is designed in consideration of the characteristics of eSIM, and supports secure communication between an eSIM-based device and a server by extending and applying the existing IoTSAFE standard. Through this, a security protocol may be implemented through a hybrid cryptographic scheme in various Internet of Things (IoT) devices using eSIM.

In addition, the proposed method/system of the present disclosure may have the technical effect of scalability for future security environments. The hybrid scheme of the present disclosure is designed to be used in parallel with conventional public key cryptography until the PQC scheme becomes established as a security standard, and provides flexibility to completely switch to the PQC scheme if the stability of the PQC scheme is guaranteed in the future. This provides the advantage of using the hybrid scheme now and flexibly adjusting the system according to the security situation in the future.

In addition, the proposed method/system of the present disclosure may have the technical effect of maintaining compatibility with conventional infrastructure. The hybrid scheme of the present disclosure provides security for the quantum computer era by adding a PQC scheme while utilizing conventional public key cryptography system and server infrastructure. Through this, the security level may be significantly improved without significantly changing the conventional infrastructure, and compatibility with newly built PQC-based systems may also be maintained.

In summary of the above-mentioned points, the proposed method/system of the present disclosure provides a security system that is safe even against the development of quantum computers through a hybrid scheme that combines the conventional cryptography and the PQC in an eSIM-based communication environment, and may provide additional security against the uncertainty of the PQC scheme. Through this, an efficient communication protocol that may secure both security and reliability may be implemented.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method for securely key sharing in a hybrid cryptography, the method comprising:
receiving a specific command indicating derivation of a shared secret according to the hybrid cryptography;
transmitting information for a public key of a first cryptography and information for a public key of a second cryptography of an embedded Subscriber Identity Module (eSIM), to a server, in response to the specific command;
receiving information for a public key of the first cryptography and encapsulated key material related to the second cryptography of the server, from the server; and
deriving the shared secret according to the hybrid cryptography by deriving a first shared secret for the first cryptography and a second shared secret for the second cryptography.

2. The method of claim 1,
wherein the specific command includes at least one of information for a public key of the first cryptography, information for a private key of the first cryptography, information for a public key of the second cryptography, or information for a private key of the second cryptography.

3. The method of claim 2,
wherein information for the public key of the first cryptography, information for the private key of the first cryptography, information for the public key of the second cryptography, and information for the private key of the second cryptography are configured based on either an identifier or a label.

4. The method of claim 2,
wherein the specific command further includes information encapsulating a shared secret for the second cryptography.

5. The method of claim 1,
wherein the shared secret according to the hybrid cryptography is derivated by concatenating the second shared secret to the first shared secret.

6. The method of claim 1,
wherein the first cryptography corresponds to a public key cryptography, and the second cryptography corresponds to a post-quantum cryptography.

7. The method of claim 1, further comprising:
receiving a command for initializing a signature generation procedure according to the hybrid cryptography; and
performing a signature exchange procedure with the server in response to the command.

8. The method of claim 7,
wherein the command includes information for a private key of the first cryptography and information for a private key of the second cryptography.

9. The method of claim 8,
wherein the information for the private key of the first cryptography and the information for the private key of the second cryptography are configured based on either an identifier or a label.

10. An apparatus of securely key sharing in a hybrid cryptography, the apparatus comprising:
at least one processor and at least one memory,
wherein the processor is configured to:
receive a specific command indicating derivation of a shared secret according to the hybrid cryptography;
transmit information for a public key of a first cryptography and information for a public key of a second cryptography of an embedded Subscriber Identity Module (eSIM), to a server, in response to the specific command;
receive information for a public key of the first cryptography and encapsulated key material related to the second cryptography of the server, from the server; and
derive the shared secret according to the hybrid cryptography by deriving a first shared secret for the first cryptography and a second shared secret for the second cryptography.

11. The apparatus of claim 10,
wherein the specific command includes at least one of information for a public key of the first cryptography, information for a private key of the first cryptography, information for a public key of the second cryptography, or information for a private key of the second cryptography.

12. The apparatus of claim 11,
wherein information for the public key of the first information for the private key of the first cryptography, cryptography, information for the public key of the second cryptography, and information for the private key of the second cryptography are configured based on either an identifier or a label.

13. The apparatus of claim 11,
wherein the specific command further includes information encapsulating a shared secret for the second cryptography.

14. The apparatus of claim 10,
wherein the shared secret according to the hybrid cryptography is derivated by concatenating the second shared secret to the first shared secret.

15. The apparatus of claim 10,
wherein the first cryptography corresponds to a public key cryptography, and the second cryptography corresponds to a post-quantum cryptography.

16. The apparatus of claim 1,
wherein the operation further comprises:
receiving a command for initializing a signature generation procedure according to the hybrid cryptography; and
performing a signature exchange procedure with the server in response to the command.

17. The apparatus of claim 16,
wherein the command includes information for a private key of the first cryptography and information for a private key of the second cryptography.

18. The apparatus of claim 17,
wherein the information for the private key of the first cryptography and the information for the private key of the second cryptography are configured based on either an identifier or a label.

19. A method for securely key sharing in a hybrid cryptography, the method comprising:
receiving a specific command indicating derivation of a shared secret according to the hybrid cryptography;
transmitting information for a public key of a first cryptography and information for a public key of a second cryptography of a server, to an embedded Subscriber Identity Module (eSIM), in response to the specific command;
receiving information for a public key of the first cryptography and encapsulated key material related to the second cryptography of the eSIM, from the eSIM; and
deriving the shared secret according to the hybrid cryptography by deriving a first shared secret for the first cryptography and a second shared secret for the second cryptography.

20. The method of claim 19, further comprising:
receiving a command for initializing a signature generation procedure according to the hybrid cryptography; and
performing a signature exchange procedure with the eSIM in response to the command.
